(19) United States
(12) Patent Application Publication
(10) Pub. No.: US 2012/0296711 A1
(43) Pub. Date: Nov. 22, 2012

(54) METHODS FOR REDUCING THE PEAK DEMAND OF ELECTRIC UTILITIES DURING AIR CONDITIONING SEASON

(76) Inventor: Lee Huffman, Santa Fe, NM (US)

(21) Appl. No.: 13/471,124

(22) Filed: May 14, 2012

Related U.S. Application Data
(60) Provisional application No. 61/488,275, filed on May 20, 2011.

(51) Int. Cl. G06Q 30/02

(52) U.S. Cl. 705/14.1

(57) ABSTRACT

A method of reducing the peak demand of electric utilities during an air conditioning season, including (a) operating electrically-powered air conditioning equipment to pre-cool a customer's building so that the pre-cooling is effective to keep the building within a desired temperature range during the entire period of the utility's peak demand and to minimize additional electrically-powered cooling of the building, (b) then substantially or completely refraining from cooling the customer's building with electrically-powered air conditioning equipment powered by the utility during the utility's entire period of peak demand later on the same day the building is pre-cooled, and (c) providing the customer of the electric utility with a financial incentive from the utility to carry out (a) and (b).

### CROSS-REFERENCE TO RELATED APPLICATION

The benefit under 35 U.S.C. §119(e) of U.S. Provisional Patent Application No. 61/488,275 filed May 20, 2011, is hereby claimed, and its entire disclosure is incorporated herein by reference.

### BACKGROUND OF THE INVENTION

1. Field of the Invention

This invention relates generally to methods for reducing the peak demand of electric utilities and more specifically to methods for operating air conditioners, refrigerators, and freezers to completely eliminate or greatly reduce their use during the period of an electric utility's peak demand.

2. Description of Relevant Art and the Problem Faced by Electric Utilities

Electric utilities provide service to their customers 24 hours per day, 365 days per year with a high level of reliability. For most utilities, service is provided in over 99.9% of the 8760 hours in a year. Sustained power outages lasting more than a day are usually the result of major natural disasters such as hurricanes or tornadoes. Even then, the response is usually well-coordinated and effective. Less frequently, prolonged service outages result from mundane but important matters such as the failure to trim trees near power lines and a cascade of transmission line failures that spreads a power outage across much of the country. “The largest blackout in North American history descended on 50 million people in eight states and Ontario.” National Geographic, The 21st Century Grid, p. 136, July 2010.

While extended blackouts command the most publicity and public awareness, public utilities shoulder an unending obligation to provide adequate, reliable service at reasonable rates or prices to their customers. Public utilities do business in several forms, including investor-owned utilities, municipally-owned utilities and rural electric cooperatives. Regardless of their form of ownership, they share common characteristics. Chief among these is their legal obligation, called a duty to serve, to provide adequate service at just and reasonable rates. They are obligated to provide adequate service both now and in the future.

To satisfy this duty to meet the future needs of its customers, an electric utility must prepare a load forecast that projects the future peak demand its customers will place on the utility's electric system. In addition, it must also have enough power available to have a safety level or reserve margin (generally 14% to 18%) of power above the expected peak demand. A reserve margin is needed to deal with contingencies such as an unplanned outage at a utility's single largest generating plant, or problems resulting from a major transmission line failure.

An electric utility must then plan, finance, and build the necessary power plants and new transmission lines to meet the future needs of its customers. To do so, it must invest large sums of money, frequently in the billions of dollars.

To meet the peak demand for electricity on a given day, and especially on the day of the year when the daily peak is also the highest level of demand on the electric system for the entire year, presents a complex set of problems. These problems involve economics, engineering, physics and meteorology, and their resolution affects entire cities and states served by public utilities.

Most electric utilities experience their annual system peak during an extended period of hot weather, when people are fatigued after several days of a heat wave. Usually beginning on the third day of a heat wave, the level of air conditioning used by customers increases compared to the first two days, even when temperatures are no higher on the third and subsequent days. Quite simply, the peak demand for electricity usually occurs when air conditioning use is at its highest. If rolling blackouts or brownouts (in which power is reduced or completely unavailable for periods of time on a rotating basis in different geographic areas) take place, there are frequently substantial economic costs, due to businesses being unable to operate normally, and the potential for extensive harm to public health due to heat stroke. The consequences of an extended blackout are more severe.

To avoid or reduce these problems, utilities run backup or peaker electric generating units during a very limited number of hours a year. These units have higher costs than large base load plants to generate a given amount of power or energy. Power is the instantaneous level of generating output expressed in watts.

Energy or work equals power multiplied by time, so a kilowatt (kw) of power generated for one hour produces one kilowatt hour (kwh) of energy. A megawatt (MW) is one million watts, and is the common unit for describing the output of a large power plant.

Because peaking units have higher per kw and kwh costs than larger baseload units that are operated most of the time, the cost to a public utility to meet the demand of its customers for air conditioning and other electric power at the time of a system peak is higher per kw and kwh than during off-peak periods. This is partly the case because electricity cannot be stored economically or on a large scale; it has to be used when generated and there has to be a balance between generation and demand. Batteries and pumped storage of water provide only a limited form of storage, and their availability does not significantly meet or reduce a utility's need for additional power during periods of peak demand. Moreover, these forms of storage require significant additional investment by electric utilities.

To the extent electric utilities can reduce the peak demand placed on their system, the economic benefits are very substantial. For the country as a whole, one study estimates annual savings of $15 billion “for shifting 5 to 8 percent of consumption from peak to off-peak hours and for depressing peak demand by 4 to 7 percent.” Scott Neumann et al., How to Get More Response From Demand Response, Elec. J., p. 25, October 2006.

The corresponding annual savings for an individual utility that achieves similar results, depending on its size, can easily run into the hundreds of millions of dollars. Understandably, the efforts directed to reducing peak demand are extensive. Large industrial customers are offered interruptible rates so that, with an agreed-upon period of prior notice, their load can be dropped by a public utility. In return for the ability of an electric utility to notify such customers (typically manufacturing, chemical processing or other large industrial customers) of an impending curtailment of their electric power service, the interruptible customer receives a reduced rate for their electric service throughout the year. There are usually limits on the number and duration of these interruptions. Smaller customers, and especially residential customers, do not generally participate in these programs.

Because electric utilities are usually considered a natural monopoly, their rates and service are subject to government control. This control can be exercised by local elected officials in the case of a municipal utility, an elected board of managers for a rural electric cooperative, or a state regulatory agency or commission in the case of investor-owned electric utilities. In any event, electric public utilities do not set their own rates or prices. They need government approval. Most businesses operate in a competitive market in which their ability to set prices is constrained by competitive forces. But most businesses do not have a legal obligation, as electric public utilities do, to provide service. In return for having a service area in which they operate, regulated electric utilities have a legal duty to serve and their rates are subject to government approval. As a result, when electric power is in short supply, they cannot raise prices on their own the way an unregulated business can during a shortage.

In an attempt to reduce the demand for electricity during their period of peak demand, some electric utilities have sought, and occasionally received, approval of pricing structures that vary with time. These different approaches are known as time-of-use rates, real time pricing, and critical peak pricing. They all involve setting rates for energy based on the cost of generation at different times of day. Most residential customers pay only a per kwh or energy charge and, unlike larger commercial or industrial customers, do not pay a separate charge based on their highest or peak demand, measured in kw.

Nationwide, most electric utility customers (especially residential customers) do not yet have the type of meters that allow for any of these rates that vary with time. As more customers receive meters that allow for determining how much energy (and power) they use on an hourly (or shorter) basis, rather than the typical monthly basis, there will likely be greater use of rates that vary with time.

Time-of-use rates have a higher rate or price during a utility's peak hours than the normal per kwh rate and a lower than normal rate during off-peak hours. The goal is to shift consumption to off-peak hours and lower the utility's peak demand. The observed reduction in the peak demand of electric utilities using time-of-use rates has generally been slight. While any reduction in an electric utility's peak demand is beneficial, there is a significant need, with commensurate benefits, for substantial additional reductions.

The other types of time-varying rates, real-time pricing and critical peak pricing, are also called dynamic pricing. They are more complex than standard time-of-use rates, and have primarily been the subject of pilot programs or other studies, without widespread implementation. Under real-time pricing, the rate for electricity can fluctuate hourly, reflecting changes in the wholesale price of electric power purchases or changes in the cost of generating power. Customers are usually notified of price changes on a day-ahead or hour-ahead basis.

Critical peak price rates are no different than time-of-use rates under most conditions. But the standard on-peak price is replaced with a much higher price under certain specific conditions. If demand is projected to be very high, normal supply becomes unavailable or there are transmission constraints, the electric utility can notify its customers who are on a critical peak price rate that during a specific timeframe (e.g., 2:00 p.m. to 5:00 p.m.) later that day or the following day, critical peak prices will be in effect. The result is that critical peak prices of perhaps ten times the normal price will be charged rather than the usual time-of-use peak prices, which are usually not more than twice the standard rate. Critical peak price conditions typically occur 10 to 12 days per year.

Studies have shown that critical peak pricing is significantly more effective than standard time-of-use rates at reducing peak demand. The Baltimore Gas & Electric Company undertook a dynamic pricing pilot program in the summers of 2008 and 2009 and tested customers' price responsiveness to different dynamic pricing options with two enabling technologies. The program tested critical peak pricing and peak time rebate tariffs on over a thousand residential customers in combination with two technologies, an in-home display known as the Energy Orb that changes color with changing electricity prices, and a switch for cycling central air conditioners. The switch allowed only a maximum of one half of the customers in the treatment group to use air conditioning at the same time. Air-conditioners were turned off half of the time during the five hours of critical peak prices.

These customers served as the treatment group and their usages were measured not only during the pilot period but also during several prior months. The remaining customers in the pilot stayed on the standard tariff and served as a control group. Hourly usage was recorded for customers in both groups during the pilot program to determine if the treatment group used less during the more expensive periods. In 2009, the study replaced the air conditioning switch with a smart thermostat that raised the set-point (the indoor temperature at which the air conditioning comes back on) during the critical peak hours.

In each of the two years, Baltimore Gas & Electric called 12 critical peak days. Customers received advance notice the previous day. The price under critical peak pricing was raised by a factor of about nine compared to the standard rate of 15 cents per kwh, with lower rates of 9 cents per kwh off peak to maintain revenue neutrality. The other approach tested was a peak time rebate calculated based on the amount of reduced usage. It was about 12.5 times greater than the standard rate, although somewhat lower amounts were also tested. Customer response to the higher critical peak prices and to the rebate were essentially the same. The critical peak prices and rebates alone (without either of the two technologies) produced load reductions during critical peak hours on critical peak days of 20% and 21%, respectively. Combined with the Energy Orb and the air conditioning switch the reductions were 32.5% and 33%, respectively. Overall energy consumption (on and off peak) increased about one percent with critical peak pricing and declined about one-half of one percent using the peak time rebate. Does Dynamic Pricing Work in the Mid-Atlantic Region?—Econometric Analysis of Experimental Data, 29th Annual Eastern Conference, Rutgers Center for Research In Regulated Industries, Ahmad Faruqui and Sanem Sergici (May 20, 2010). While these peak load reductions are significantly higher than those achieved with standard time-of-use rates, the present invention has the potential for achieving even larger reductions.

There have been other approaches to reducing the peak load of electric utilities. U.S. Patent Application Publication No. US 2011/0006123 A1 by Sharp discloses an electronic control system that reduces the simultaneous operation of multiple air conditioning units. It spreads electric load and reduces peak demand. U.S. Patent Application Publication No. US 2009/0248217 A1 by Verfuerth discloses a system and method to reduce electricity use during periods of peak demand in which an electricity supplier to users of high-intensity fluorescent lighting equipment sends a signal to turn off some of this equipment during periods of peak demand.

U.S. Pat. No. 4,228,511 to Simcoe discloses systems and methods for shifting electric load for air conditioning from periods of peak demand. Electric power consumption is deferred during peak conditions by boosting the thermostat set point at a controlled rate.

U.S. Patent Application Publication No. US 2007/0227721 A1 to Springer discloses a method of nighttime pre-cooling of a building using outside air that is colder than air inside the building. To reach the desired temperature inside the building, the nighttime outside air pre-cooling can be followed if necessary by pre-cooling with air that is cooled by vapor compression processes. The latter is used if the indoor temperature was not lowered to the desired temperature by ventilating the building with cool outdoor air. The vapor compression air conditioner is operated at any time if the current indoor air temperature is greater than the maximum indoor temperature setting. As a result, whenever the indoor air temperature rises to this level, the air conditioner will come on, including during periods of peak demand.

### SUMMARY OF INVENTION

The invention provides a method of daytime pre-cooling of a building using air conditioning powered by an electric utility that reduces the peak demand experienced by the utility on the same day the building is pre-cooled.

Accordingly, the invention provides a method in which the daytime pre-cooling of a building is effective to keep the building within a desired temperature range for the entire period of an electric utility's peak demand so that additional electrically-powered cooling of the building by the utility is not needed or substantially used during the entire period of the electric utility's peak demand on the same day the building is pre-cooled.

It is an object of this invention to reduce the peak demand of electric utilities during their air conditioning season.

It is another object of this invention to reduce the need of electric utilities for new generating capacity, new purchases of wholesale power, and new transmission lines.

It is a further object of this invention to reduce the amount of money electric utilities need to invest in new generating plant and transmission lines.

It is still another object of this invention to reduce the peak demand of electric utilities on critical peak days during their air conditioning season.

It is yet another object of this invention to provide electric utility customers with a financial incentive to pre-cool their buildings to such an extent that they will completely or substantially refrain from using air conditioning during the entire period of their electric utility's peak demand on the same day their building is pre-cooled.

It is another object of this invention to provide a method in which buildings can be effectively pre-cooled with an electrically-powered air conditioner during one or more of the following time periods: mid-morning (8:00 a.m. to 10:00 a.m.), late-morning (10:00 a.m. to 12 noon), and early afternoon (12 noon to 2:00 p.m.), so that additional use of air conditioners is not needed during an electric utility's entire period of peak demand on the same day.

It is another object of this invention to provide a method for pre-cooling a freezer or refrigerator so that the peak demand of an electric utility is reduced on the day of pre-cooling.

To achieve the foregoing and other objects, and in accordance with the purposes of the present invention, there is provided a method of reducing the peak demand of electric utilities during their air conditioning season. The method includes (a) operating electrically-powered air conditioning equipment to pre-cool to a temperature of no higher than 69° F. a building used by a customer of an electric utility in a first time period after 8:00 a.m. and prior to the utility's period of peak demand on the same day the building is pre-cooled, so that the pre-cooling is effective to keep the building within a desired temperature range during the entire period of the utility's peak demand and so that additional electrically-powered cooling of the building by the utility is not needed or substantially used during the entire period of the utility's peak demand on the same day the building is pre-cooled; (b) then substantially or completely refraining from cooling the customer's building with electrically-powered air conditioning equipment powered by the utility during the utility's entire period of peak demand later on the same day the building is pre-cooled; and (c) providing the customer of the electric utility with a financial incentive from the utility to pre-cool the building during the first time period and to completely or substantially refrain from using electrically-powered air conditioning equipment powered by the utility to cool the building during the electric utility's entire period of peak demand on the same day the building is pre-cooled.

The financial incentive can be calculated based on either the customer's reduction in their energy usage (in kwh) or reduction in their maximum demand (in kw) compared to their normal pattern of use. The financial incentive can take the form of a substantially reduced energy (kwh) rate for energy used during the first time period when the building is pre-cooled. It can additionally take the form of a rebate calculated based on the amount of the customer's reduction in their energy usage (in kwh) or their reduction in the maximum power (in kw) they use during the utility's period of peak demand on the same day the building is pre-cooled.

If a customer elects to take service under a program that provides them with a financial incentive to reduce their electricity usage during the utility's period of peak demand by pre-cooling, the financial incentive can also be a much higher than normal rate for the electric energy (in kwh) they use during the utility's peak period. The higher charge can apply to all such electric energy usage or only to the portion above a baseline of historic use that is attributable to air conditioning use during the utility's period of peak demand.

The method of this invention can be used every day during an electric utility's air conditioning season or it can be used only on days of anticipated extremely high electric demand due to a heat wave, or other problems such as unplanned generating plant outages or transmission system constraints. These types of events give rise to critical peak days when an electric utility's system is operating near or at its maximum capacity.

The method of this invention can also be used to reduce an electric utility's peak demand by pre-cooling food storage devices such as freezers or refrigerators to a lower than usual temperature (or set point) by at least four degrees Fahrenheit so that additional cooling is not needed during most or all of the utility's period of peak demand.

One advantage of the present invention is that the peak demand of electric utilities can be significantly reduced.

Another advantage is that electric utility peak demand reduction can be achieved without making large investments in pumped storage technology or to retrofit existing buildings to provide for nighttime pre-cooling with outside air.

Still another advantage of the present invention is that the peak demand of utilities can be significantly reduced because a large percentage of their customers should be willing to participate in a program that both rewards them financially for shifting their air conditioning load to off-peak periods and does not require them to raise the temperature setting of their building above its normal summer temperature.

Another advantage of this invention is that the borrowing and investment needs of electric utilities will be reduced because they will not need as much new generating plant. As a result, their overall costs of providing service and rates will be lower, over time, than otherwise.

Another advantage of the invention is that while electricity itself cannot be stored economically, using the methods of the invention allows work performed by electricity to pre-cool a building to be economically stored on a large scale and with reasonable efficiency.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the methods particularly pointed out in the appended claims.

### DETAILED DESCRIPTION

The present invention provides methods for electric utilities to significantly reduce the peak or highest power demand placed on their systems during their air conditioning season. Achieving this reduction in demand is very valuable. The method involves three main, interrelated elements. Electric utility customers pre-cool their buildings before the daily peak with air-conditioning, they then refrain from additional cooling with air-conditioning during the period of peak demand later the same day and the electric utility provides them with a financial incentive to do this.

The methods of this invention can be used for any type of building that is air-conditioned, whether it be a residence or a commercial building, including office buildings or retail stores. Different types of buildings will have different needs and operating characteristics, but their owners or tenants can all participate in the methods disclosed.

The majority of electric utility customers are individuals who live in houses, apartments, condominiums, or townhouses. They are all members of the electric utility's residential class of customers. Larger business customers are members of the commercial or industrial class. Residential customers pay a fixed per-month customer charge and a second charge for each kwh of energy they use. For residential customers, unlike larger customers, there is unusually no additional charge based on the highest demand, or level of instantaneous power in kw, they place on the system.

The purpose of the present invention is to reduce the peak demand placed on electric utilities. This purpose is accomplished by the methods of the present invention which financially reward electric utility customers who shift some or all of their electric air-conditioning load from peak to off-peak periods in the mid- (8:00 a.m. to 10:00 a.m.) or late (10:00 a.m. to noon) morning or early afternoon (noon to 2:00 p.m.), all of which are prior to the utility's usual period of peak demand. For most electric utilities with a significant air-conditioning load, the peak period will last at least several hours and generally begin by 2:00 p.m. or 3:00 p.m. and end in a range somewhere between about 6:00 p.m. and 7:00 p.m.

The approach of a typical residential customer to using air-conditioning is instructive. A typical homeowner or renter leaves their house or apartment for work in the morning and returns in late afternoon or early evening. Such non-holiday weekdays coincide with an electric utility's highest level of demand. Weekend and holiday weekday electric peak loads are generally lower.

On a day when temperatures will be very high, the individual has a decision. They can turn their air-conditioning completely off that day, and decide on the level of cooling to use when they return home. Or they can set their thermostat at a fairly high or warm setting such as in a range of 78° F. to 82° F., to save money compared to a lower setting, and do most of their cooling later. If they come home and their home has heated up a great deal during the day (for example, from 74° F. when they left to 80° F. or higher), the usual reaction will be to turn on the air-conditioning, which will run continuously until their home is cooled to the desired temperature which could often be in a range of 72° F. to 76° F. For most people, this late afternoon or early evening cooling will take place during and contribute to their local electric utility's period of peak demand.

If, instead, they leave the air-conditioning on while they are at work or out for the day, they may typically set it at a high or warm set point temperature such as 78° F. or 80° F. (compared to their normal setting, whether it is 73° F. or 75° F.), to both limit the maximum temperature they will return home to and to save money on air-conditioning while they are away. In this situation, their home or apartment will gradually warm up from its initial morning temperature of typically 73° F. to 75° F. over the course of the day to a much warmer temperature, as the outside temperature rises to its ultimate high of 85° F., 90° F., or higher than 95° F. in a heat wave, or higher than 100° F. or 105° F. in locations such as Phoenix or Las Vegas, on a regular basis and for months at a time.

In these locations, and others such as Atlanta and Houston, air-conditioning is a daily necessity, or at least a strong preference. The well-known economist Samuelson pointed out decades ago that the widespread introduction of air-conditioning in the 1960s helped reverse population declines in the South and made the sunbelt boom possible. Obviously, local climate varies a great deal across the country, but electric utilities have a duty to meet their customers' needs even in the most extreme conditions of heat and/or humidity in their area. Any general warming trend makes this obligation more important, and more expensive.

Many homes have the air-conditioning turned on during the day on non-holiday weekdays. In this situation, with people at home, as the homes warm up the air-conditioning comes on usually by early afternoon, and continues to run on an intermittent basis so as to maintain the set point or maximum temperature people have chosen, whether it is a cool (and expensive) 72° F., the more prevalent 75° F., or a warm 78° F.

This sustained period of afternoon cooling keeps millions of air-conditioners running throughout the mid and late afternoon, and early evening, across most parts of the country. Coastal regions such as San Francisco are a notable exception, but even Minneapolis, Milwaukee, and Green Bay reach temperatures at times between 95° F. and 100° F.

Business customers, including stores and office buildings, need to keep their inside temperatures in an acceptable range. They generally do not want to start the day off too cold, such as below 70° F. and, morning or afternoon, they generally aim for a temperature of no more than 75° F. To save money, or avert blackouts, they will sometimes raise this 75° F. maximum or set point to 77° F. or 78° F.

The chief benefit of the methods of the present invention is that much of the present level of afternoon peak cooling can be successfully shifted to off-peak periods in the mid (8:00 a.m. to 10:00 a.m.) or late (10:00 a.m. to noon) morning, or early afternoon (noon to 2:00 p.m.) before the local system peak. Obviously, if the local peak demand period starts later, for example at 3:00 p.m., pre-cooling can continue later in the day.

In a preferred embodiment of the invention an unoccupied home or apartment will be pre-cooled from an initial temperature of about 74° F. to a temperature of no higher than 69° F., and preferably to a lower temperature of about 64° F. or 65° F. For an occupied home or apartment pre-cooling will be to a temperature of no higher than 69° F. and preferably to a temperature of about 67° F., depending on individual preference. The pre-cooling can take place in one or more of the mid-morning, late morning, and early afternoon time periods. It can be done all at once or in two or more steps. There can be a final pre-cooling step in the early afternoon (prior to peak) to make sure, or greatly increase the chance, that no on-peak cooling will take place. The details of a schedule for pre-cooling many homes and apartments on a rotating or staggered basis to spread out load during the pre-cooling (or first) period prior to the utility's peak period will be readily handled by the local electric utility. Participation in the pre-cooling incentive program is expected to be voluntary for utility customers.

A very similar process will be conducted by commercial or business customers participating in an electric utility's peak load reduction (and incentive rates) program. During the mid and late morning, instead of maintaining indoor temperatures typically between 73° F. and 75° F., business customers who participate will pre-cool to a temperature of no higher than 69° F. Then, in a preferred embodiment they can, after temperatures rise to about 71° F. or 72° F., conduct additional pre-cooling during the early afternoon (noon to 2:00 p.m.) but before the local utility peak, to a temperature no higher than 69° F. and preferably to about 67° F. or 68° F. In this way, the inside temperature of the office building, store, or other commercial customer building should be able to avoid any additional air-conditioning use (powered by the electric utility) during the following three-, four-, or five-hour peak period. The building will gradually warm up that afternoon, but even at a rate of two degrees per hour, additional cooling will not be needed in most cases for the rest of the peak period on the day the pre-cooling is performed. For most of the afternoon people in stores and offices that pre-cool will experience temperatures generally between 68° F. and 73° F. rather than having temperatures between 74° F. and 77° F.

To make the methods of this invention work, a significant number of customers will need to be motivated to participate. An electric utility can achieve the necessary motivation, secure a large level of participation by its customers, and significantly reduce its peak demand by providing its customers with a financial incentive. In short, if the electric utility provides its customers who participate in a pre-cooling (and corresponding peak period no or reduced cooling) program with a financial incentive, participation levels should be high enough to significantly reduce peak demand.

The incentive electric utilities provide will include, in a preferred embodiment, a significantly reduced energy (kwh) rate during the approximately six-hour long pre-cooling or first period that begins at 8:00 a.m. and generally ends at 2:00 p.m. It will, in addition, in a preferred embodiment, also include either an opportunity to earn a peak time rebate for reducing energy usage (or demand) during the period of the utility's peak demand, or include a much higher price for energy usage (dynamic peak pricing) during the peak period. During the post-peak hours (e.g. after 7:00 p.m.) and overnight, the standard rate will be provided to customers on the program.

The pre-cooling period incentive rate will still be high enough to recover the utility's marginal costs of providing energy, including fuel and/or purchased power costs. An example of such rates is as follows. For an electric utility that normally charges ten cents ($0.10) per kwh, the new rate structure, in a preferred embodiment, could instead be 50 to 60 percent lower (i.e., a reduction of five cents to six cents per kwh) during the incentive pre-cooling period of 8:00 a.m. to 2:00 p.m. During the peak period (e.g., 2:00 p.m. to 6:00 p.m. or 7:00 p.m.) there would either be a substantially higher rate for energy or instead the standard ten cent rate would apply, with an opportunity to receive a rebate for reduced energy consumption during the peak period.

An effective incentive can be provided to residential and commercial customers by either providing them with a rebate for reduced peak period usage (for commercial customers the rebate can be calculated based on their reduction in peak demand or their reduction in peak period energy usage), or charging a much higher energy rate (or demand charge to larger commercial customers) during the utility's peak period. For a residential customer now paying a uniform ten cents per kwh at any time of the day, an increased rate during the peak period would be in a range of 8 to 12 times as much ($0.80 to $1.20) per kwh in a preferred embodiment of the invention. This would provide an incentive to reduce peak period use, although other high charges could also be effective. Increased energy or demand charges of a similar magnitude can be applied to commercial customers.

For this same typical residential customer now paying ten cents per kwh, an alternative and equally effective incentive is to provide the customer a rebate based on the amount of their reduction in energy use during the peak period. For commercial customers, the rebate could be based on their reduced energy use or on the reduction in their peak demand. In a preferred embodiment of the present invention, a rebate in the range of eight to fourteen times the standard ten cents per kwh rate is paid by the utility to the residential customer for each kwh by which the customer lowers its peak period usage compared to the customer's previous usage during the peak period. Such a customer would save up to $1.40 for each kwh of reduced energy consumption during the peak period.

In addition to the methods disclosed, the use of certain enabling technologies in conjunction with these methods will further reduce the peak demand experienced by electric utilities. A well-known device in this regard is the Energy Orb, which uses different colors to show customers that different electric rates are in effect. A variation on this device would be well-suited for use with the methods of the present invention. A four-color device could be used as follows. Blue would indicate that the lowest rate of the day (the first period pre-cooling incentive rate) applies. Green would indicate that the off-peak, overnight rate is in effect. Yellow would indicate that the peak period rate applies. This rate would be the very high (8 to 12 times the standard 24 hour per day rate) rate under one embodiment of the invention. During critical peak pricing period, the color displayed would be red. This would inform a customer that energy rates even higher than the normal peak period rates would be charged.

The present invention is best used in conjunction with a programmable thermostat. The pre-cooling during the first time period could be performed on a schedule chosen by an individual customer or by the utility if the customer did not choose a schedule. A customer would be able to program the thermostat so that air-conditioning would not be used at all during the peak period. And the customer can always choose to turn the air-conditioning off for the entire day.

Customers would have the ability to use air-conditioning during the peak period. Doing so would reduce the rebate they receive from their electric utility if they receive service under a rate that provides rebates as an incentive. If they instead receive service under the very high peak period rate, their usage during peak would increase their bill, rather than reducing their rebate.

The second enabling device that is well-suited for use with the methods of the present invention is a switch of the type used by electric utilities to cycle off and on groups of air-conditioners. Electric utilities can use switches to keep one-half of air-conditioners turned off at any one time during periods of peak demand.

The practice of the methods of the present invention contemplates using switches to cycle air-conditioners off and on in more than two groups, so that when a commercial or residential customer turns up the air-conditioning during a peak period by lowering the thermostat, the customer can be placed in a group of similar customers who will receive air-conditioning service for the next 20 minutes, 15 minutes, or 12 minutes (depending on how stressed the electric system is that day) and then not receive such service again until one hour has passed from the time they started to receive air-conditioning service. In this way, during the peak period, an electric utility can limit the operation of air-conditioners to a maximum of ⅓, ¼, or ⅕ of its customers at any moment.

The present invention can also be used to reduce the peak demand of electric utilities by pre-cooling food storage devices such as freezers or refrigerators. Programmable thermostats can automatically activate this function during the air-conditioning season. Modern freezers and refrigerators, particularly when not opened for several hours at a time, have a low rate of heat exchange with ambient indoor air. By pre-cooling a freezer by about 8° F. to 10° F. in the first period prior to the peak period, a customer will make it unnecessary to cool the freezer at all during the following peak period that day.

Refrigerators can be pre-cooled during the first period from a temperature of their usual setting of about 40° F. to a temperature in a range of no lower than 35° F. to about 36° F. In this way, fresh food will not be frozen, and the need for any additional cooling during the peak period that afternoon can be significantly reduced, especially if the refrigerator door is not opened frequently during the peak period later that day.

The foregoing description of several embodiments of the invention has been presented for purposes of illustration and description. It is not intended to be exhaustive or to limit the invention to the precise methods disclosed. They were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method of reducing the peak demand of an electric utility during its air conditioning season comprising:
(a) operating electrically-powered air conditioning equipment to pre-cool, to a temperature of no higher than 69° F., a building used by a customer of said electric utility in a first time period after 8:00 a.m. and prior to said utility's period of peak demand on the same day said building is pre-cooled, so that the pre-cooling is effective to keep said building within a desired temperature range during said period of peak demand and so that additional electrically-powered cooling of said building by said utility is not needed or substantially used during the entire period of said electric utility's peak demand on the same day said building is pre-cooled;
(b) then completely or substantially refraining from cooling said customer's building with electrically-powered air conditioning equipment powered by said electric utility during said utility's entire period of peak demand later on the same day said building is pre-cooled; and
(c) providing said customer of said electric utility with a financial incentive from said utility to pre-cool said building during said first time period and to completely or substantially refrain from using electrically-powered air conditioning equipment powered by said utility to cool said building during said electric utility's entire period of peak demand on the same day said building is pre-cooled.

2. The method of claim 1 further comprising calculating the amount of the financial incentive provided to said customer based on the amount of said customer's reduction in their individual maximum demand placed on said electric utility's system during said peak period, compared to their historic individual maximum demand during said peak period.

3. The method of claim 2 further comprising providing a financial incentive that includes a substantially reduced kwh (kilowatt hour) rate during said first time period.

4. The method of claim 2 further comprising paying a financial incentive to said customer that includes a rebate based on said customer's decrease in their individual maximum demand in kw placed on said utility during said peak period.

5. The method of claim 1 further comprising calculating the amount of the financial incentive provided to said customer based on the amount of said customer's reduction in their individual energy (kwh) usage during said peak period compared to their historic individual energy usage during said peak period.

6. The method of claim 5 further comprising providing a financial incentive that includes a substantially reduced kwh (kilowatt hour) rate during said first time period.

7. The method of claim 5 further comprising paying a financial incentive to said customer that includes a rebate based on said customer's decrease in their individual energy usage during said peak period.

8. The method of claim 1 further comprising determining the financial incentive provided to any customer who uses said electrically powered air conditioning equipment for a portion of any hour of said peak period by charging a substantially higher energy rate per kwh.

9. A method of reducing the peak demand of an electric utility during its air conditioning season on critical peak days comprising:
(a) operating electrically-powered air conditioning equipment to pre-cool, to a temperature of no higher than 69° F., a building used by a customer of said electric utility in a first time period after 8:00 a.m. and prior to said utility's period of peak demand on the same day said building is pre-cooled, so that the pre-cooling is effective to keep said building within a desired temperature range during said period of peak demand and so that additional electrically-powered cooling of said building by said utility is not needed or substantially used during the entire period of said electric utility's peak demand on the same day said building is pre-cooled;
(b) then completely or substantially refraining from cooling said customer's building with electrically-powered air conditioning equipment powered by said electric utility during said utility's entire period of peak demand later on the same day said building is pre-cooled; and
(c) providing said customer of said electric utility with a financial incentive from said utility to pre-cool said building during said first time period and to completely or substantially refrain from using electrically-powered air conditioning equipment powered by said utility to cool said building during said electric utility's entire period of peak demand on the same day said building is pre-cooled.

10. The method of claim 9 further comprising calculating the amount of the financial incentive provided to said customer based on the amount of said customer's reduction in their individual maximum demand placed on said electric utility's system during said peak period, compared to their historic individual maximum demand during said peak period.

11. The method of claim 9 further comprising providing a financial incentive that includes a substantially reduced kwh (kilowatt hour) rate during said first time period.

12. The method of claim 9 further comprising paying a financial incentive to said customer that includes a rebate based on said customer's decrease in their individual maximum demand in kw placed on said utility during said peak period.

13. The method of claim 9 further comprising calculating the amount of the financial incentive provided to said customer based on the amount of said customer's reduction in their individual energy (kwh) usage during said peak period compared to their historic individual energy usage during said peak period.

14. The method of claim 13 further comprising charging a substantially reduced kwh (kilowatt hour) rate during said first time period.

15. The method of claim 13 further comprising paying a financial incentive to said customer that includes a rebate based on said customer's decrease in their individual energy usage during said peak period.

16. The method of claim 9 further comprising determining the financial incentive provided to any customer who uses said electrically powered air conditioning equipment for a portion of any hour of said peak period by charging a substantially higher energy rate per kwh.

17. A method of reducing the peak demand of an electric utility during its air conditioning season comprising:
(a) operating an electrically-powered food storage device to pre-cool, to a temperature at least 4° F. below its normal temperature setting, said food storage device used by a customer of said electric utility in a first time period after 8:00 a.m. and prior to said utility's period of peak demand on the same day said device is pre-cooled, so that the pre-cooling is effective to keep said device within a desired temperature range during said period of peak demand and so that additional electrically-powered cooling of said device by said utility is not needed or substantially used during the entire period of said electric utility's peak demand on the same day said device is pre-cooled;
(b) then completely or substantially refraining from cooling said customer's food storage device with electrical power provided by said electric utility during said utility's entire period of peak demand later on the same day said device is pre-cooled; and
(c) providing said customer of said electric utility with a financial incentive from said utility to pre-cool said device during said first time period and to completely or substantially refrain from using electrical power provided by said utility to cool said device during said electric utility's entire period of peak demand on the same day said device is pre-cooled.

18. The method of claim 17 wherein said food storage device is pre-cooled on critical peak days.
